(19) United States
(12) Patent Application Publication
(10) Pub. No.: US 2025/0088480 A1
(43) Pub. Date: Mar. 13, 2025

(54) CONNECTING SERVICES RUNNING ON DIFFERENT NETWORKS WITH OVERLAPPING IP ADDRESSES

(71) Applicant: 3nets.io, Inc., Santa Clara, CA (US)

(72) Inventors: Gavril-Ioan Florian, Chitila (RO); Corneliu-Ilie Calciu, Bucharest (RO); Ragho Mahalingam, Nashua, NH (US); Immanuel Rahardja, Fremont, CA (US); Abraham Pucheril, Highlands Ranch, CO (US)

(21) Appl. No.: 18/367,948

(22) Filed: Sep. 13, 2023

(51) Int. Cl. H04L 61/2514; H04L 45/74; H04L 61/4511

(52) U.S. Cl. CPC H04L 61/2514; H04L 45/74; H04L 61/4511

(57) ABSTRACT

An apparatus for connecting services between a remote and local networks includes a packet receiver module that receives a data packet from a local computing device on the local network, which is sent to a remote computing device on the remote network connected to the local network. Computing devices of the local and remote networks include a same local subnet. The data packet includes a source address with the local subnet and device ID of the local computing device and a destination address includes a virtual subnet and device ID of the remote computing device. The apparatus includes a virtual address module that changes the local subnet of the source IP address of the outgoing data packet to the virtual subnet and changes the virtual subnet of the destination IP address to the local subnet, and a transmission module that transmits the outgoing data packet to the remote computing device.

### FIELD

This invention relates to networking and more particularly relates to connecting services running on different networks with overlapping internet protocol (“IP”) addresses.

### BACKGROUND

Connecting services in different networks is something very popular and is done by using a layer 3 router. This design works only when the IP address ranges of those subnets does not overlap each other. Typically, this situation is avoided by the network administrator or by the network controller, assigning IP address subnets from a single pool.

However, there are real life situations when the networks are designed separately, by different administrators or even by different organizations where the allocated subnets may overlap. In this situation, if there is a need to connect one or multiple services running in those different networks, typically, the network administrator needs to configure network address translation (“NAT”) for each service in each direction.

### SUMMARY

An apparatus for connecting services between a remote network and a local network includes a packet receiver module configured to receive, at a gateway, an outgoing data packet from a local computing device connected to a local network. The outgoing data packet is being sent to a remote computing device on a remote network connected to the local network over a connecting network. Computing devices of the local network include IP addresses with a local subnet matching a local subnet of IP addresses of computing devices of the remote network. The outgoing data packet includes a source IP address with the local subnet and a device identifier (“ID”) of the local computing device and a destination IP address includes a virtual subnet and device ID of the remote computing device. The virtual subnet is non-overlapping with the local subnet. The apparatus includes a virtual address module configured to change the local subnet of the source IP address of the outgoing data packet to the virtual subnet and changing the virtual subnet of the destination IP address to the local subnet, and a transmission module configured to transmit the outgoing data packet to the remote computing device. At least a portion of the modules include one or more of hardware circuits, programmable hardware circuits and executable code. The executable code is stored on one or more computer readable storage media.

A method for connecting services between a remote network and a local network includes receiving, at a gateway, an outgoing data packet from a local computing device connected to a local network. The outgoing data packet is being sent to a remote computing device on a remote network connected to the local network over a connecting network. Computing devices of the local network include IP addresses with a local subnet matching a local subnet of IP addresses of computing devices of the remote network. The outgoing data packet includes a source IP address with the local subnet and a device ID of the local computing device and a destination IP address includes a virtual subnet and device ID of the remote computing device. The virtual subnet is non-overlapping with the local subnet. The method includes changing the local subnet of the source IP address of the outgoing data packet to the virtual subnet and changing the virtual subnet of the destination IP address to the local subnet, and transmitting the outgoing data packet to the remote computing device.

An apparatus for connecting services between a remote network and a local network includes a network ID module configured to determine that a local network and a remote network have a same local subnet, and in response to determining that the local network and remote network comprise the same local subnet, to create a virtual subnet. The virtual subnet is non-overlapping with the local subnet. The apparatus includes a DNS server replicator configured to peer with a DNS server of the local network and/or a DNS server of the remote network and to identify, to the DNS server of the local network, computing devices of the remote network as having IP addresses with the virtual subnet, and to identify, to the DNS server of the remote network, computing devices of the local network as having IP addresses with the virtual subnet. The DNS server of the local network identifies, to the computing devices of the local network, the computing devices of the remote network as having IP addresses with the virtual subnet, and identifies, to the computing devices of the remote network, the computing devices of the local network as having IP addresses with the virtual subnet. At least a portion of the modules comprise one or more of hardware circuits, programmable hardware circuits and executable code. The executable code is stored on one or more computer readable storage media.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating a system with a local network and a remote network with overlapping IP addresses and a local gateway with a translation apparatus for connecting services between the remote network and the local network, according to various embodiments;

FIG. 1B is a schematic block diagram illustrating a system with a local network and a remote network with overlapping IP addresses and a local gateway and a remote gateway each with a translation apparatus for connecting services between the remote network and the local network, according to various embodiments;

FIG. 2 is a schematic block diagram illustrating a system with a local network and two remote networks with overlapping IP addresses and a local gateway with a translation apparatus for connecting services between the two remote networks and the local network, according to various embodiments;

FIG. 3A is a schematic block diagram illustrating a system with a local network and a remote network with overlapping IP addresses and a local gateway with a translation apparatus for connecting services between the remote network and the local network where the translation apparatus includes a Domain Name System (“DNS”) server replicator, according to various embodiments;

FIG. 3B is a schematic block diagram illustrating a system with a local network and a remote network with overlapping IP addresses and a local gateway with a translation apparatus for connecting services between the remote network and the local network where the local network includes a DNS server replicator, according to various embodiments;

FIG. 3C is a schematic block diagram illustrating a system with a local network and a remote network with overlapping IP addresses and a local gateway with a translation apparatus for connecting services between the remote network and the local network where the remote network includes a DNS server replicator, according to various embodiments;

FIG. 3D is a schematic block diagram illustrating a system with a local network and a remote network with overlapping IP addresses and a local gateway with a translation apparatus for connecting services between the remote network and the local network where a connecting network is connected to a DNS server replicator, according to various embodiments;

FIG. 4 is a schematic block diagram illustrating an apparatus for connecting services between a remote network and a local network with overlapping IP addresses, according to various embodiments;

FIG. 5 is a schematic block diagram illustrating another apparatus for connecting services between a remote network and a local network with overlapping IP addresses, according to various embodiments;

FIG. 6 is a schematic flowchart diagram illustrating a method for transmitting an outgoing data packet from a local network to a remote network with overlapping IP addresses, according to various embodiments;

FIG. 7 is a schematic flowchart diagram illustrating a method for transmitting an incoming data packet from a remote network to a local network with overlapping IP addresses, according to various embodiments;

FIG. 8A is a first part of a schematic flowchart diagram illustrating a method for managing IP addresses and data packet transmission for a connected local network and remote network with overlapping IP addresses, according to various embodiments; and

FIG. 8B is a second part of the schematic flowchart diagram of FIG. 8A, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing, which are all non-transitory. A computer readable storage medium, as used herein and including the examples listed above, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device, which are non-transitory and may be called a computer readable storage medium, would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for connecting services between a remote network and a local network includes a packet receiver module configured to receive, at a gateway, an outgoing data packet from a local computing device connected to a local network. The outgoing data packet is being sent to a remote computing device on a remote network connected to the local network over a connecting network. Computing devices of the local network include IP addresses with a local subnet matching a local subnet of IP addresses of computing devices of the remote network. The outgoing data packet includes a source IP address with the local subnet and a device identifier (“ID”) of the local computing device and a destination IP address includes a virtual subnet and device ID of the remote computing device. The virtual subnet is non-overlapping with the local subnet. The apparatus includes a virtual address module configured to change the local subnet of the source IP address of the outgoing data packet to the virtual subnet and changing the virtual subnet of the destination IP address to the local subnet, and a transmission module configured to transmit the outgoing data packet to the remote computing device. At least a portion of the modules include one or more of hardware circuits, programmable hardware circuits and executable code. The executable code is stored on one or more computer readable storage media.

In some embodiments, the packet receiver module is configured to receive an incoming data packet being transmitted to the local computing device from the remote computing device. The incoming data packet includes a source IP address with the local subnet and a destination IP address with the virtual subnet. In the embodiments, the virtual address module is configured to change the local subnet of the source IP address to the virtual subnet and to change the virtual subnet of the destination IP address to the local subnet, and the transmission module is configured to transmit the incoming data packet to the local computing device.

In some embodiments, data packets transmitted over the connecting network are transmitted via a tunnel and the apparatus includes a tunnel module configured to encapsulate, based on a tunnel protocol of the tunnel, and/or encrypt the outgoing data packet in response to the virtual address module changing the source IP address and the destination IP address of the outgoing data packet and the transmission module is configured to transmit the encapsulated and/or encrypted outgoing data packet via the tunnel. In the embodiments, the tunnel module is configured to decapsulate, based on the tunnel protocol, and/or decrypt the incoming data packet received from the packet receiver module. The virtual address module changes the source IP address and the destination IP address in response to the tunnel module decapsulating and/or decrypting the incoming data packet.

In some embodiments, the apparatus includes a Domain Name System (“DNS”) server replicator configured to identify, to the computing devices of the local network, the computing devices of the remote network as having IP addresses with the virtual subnet, and identify, to the computing devices of the remote network, the computing devices of the local network as having IP addresses with the virtual subnet. In other embodiments, the DNS server replicator is configured to peer with a DNS server of the local network and/or a DNS server of the remote network and to identify, to the DNS server of the local network, the computing devices of the remote network as having IP addresses with the virtual subnet, and to identify, to the DNS server of the remote network, the computing devices of the local network as having IP addresses with the virtual subnet.

In some embodiments, the virtual subnet includes the local subnet with at least a portion of the local subnet changed to a different value. In other embodiments, the gateway is a tunnel endpoint of a tunnel connecting the local network with the remote network. In other embodiments, the connecting network is a public network.

In some embodiments, the remote network is a first remote network and a second remote network is connected to computing devices where the computing devices of the local network, the first remote network, and the second remote network each have IP addresses with a same local subnet. In the embodiments, the virtual subnet is a first virtual subnet and a second virtual subnet is included where the second virtual subnet is non-overlapping with the local subnet and the first virtual subnet. In the embodiments, the packet receiver module is further configured to receive, at the gateway, a first outgoing data packet from the local computing device being sent to a first remote computing device on the first remote network. The first outgoing data packet includes a source IP address with the local subnet and the device ID of the local computing device and a destination IP address includes the first virtual subnet and a device ID of the first remote computing device. The packet receiver module also receives second outgoing data packet from the local computing device being sent to a second remote computing device on the second remote network. The second outgoing data packet includes a source IP address with the local subnet and the device ID of the local computing device and a destination IP address includes the second virtual subnet and a device ID of the second remote computing device.

In the embodiments, the virtual address module is further configured to change, for the first outgoing data packet, the local subnet of the source IP address to the first virtual subnet and to change the first virtual subnet of the destination IP address to the local subnet, and to change, for the second outgoing data packet, the local subnet of the source IP address to the second virtual subnet and to change the second virtual subnet of the destination IP address to the local subnet. In the embodiments, the transmission module is further configured to transmit the first outgoing data packet to the first remote computing device and to transmit the second outgoing data packet to the second remote computing device.

In some embodiments, the apparatus includes a network ID module configured to determine that the local network and the remote network have the same local subnet, and in response to determining that the local network and remote network comprise the same local subnet, create the virtual subnet.

A method for connecting services between a remote network and a local network includes receiving, at a gateway, an outgoing data packet from a local computing device connected to a local network. The outgoing data packet is being sent to a remote computing device on a remote network connected to the local network over a connecting network. Computing devices of the local network include IP addresses with a local subnet matching a local subnet of IP addresses of computing devices of the remote network. The outgoing data packet includes a source IP address with the local subnet and a device ID of the local computing device and a destination IP address includes a virtual subnet and device ID of the remote computing device. The virtual subnet is non-overlapping with the local subnet. The method includes changing the local subnet of the source IP address of the outgoing data packet to the virtual subnet and changing the virtual subnet of the destination IP address to the local subnet, and transmitting the outgoing data packet to the remote computing device.

In some embodiments, the method includes receiving, at the gateway, an incoming data packet being transmitted to the local computing device from the remote computing device. The incoming data packet includes a source IP address with the local subnet and a destination IP address with the virtual subnet. The method includes changing the local subnet of the source IP address to the virtual subnet and changing the virtual subnet of the destination IP address to the local subnet, and transmitting the incoming data packet to the local computing device. In other embodiments, data packets transmitted over the connecting network are transmitted via a tunnel and the method includes encapsulating, based on a tunnel protocol of the tunnel, and/or encrypting the outgoing data packet in response to changing the source IP address and the destination IP address of the outgoing data packet and transmitting the outgoing data packet includes transmitting the encapsulated and/or encrypted outgoing data packet via the tunnel. In the embodiments, the method includes decapsulating, based on the tunnel protocol, and/or decrypting the incoming data packet. Changing the source IP address and the destination IP address is in response to decapsulating and/or decrypting the incoming data packet.

In some embodiments, the method includes, at a DNS server replicator, identifying, to the computing devices of the local network, the computing devices of the remote network as having IP addresses with the virtual subnet, and identifying, to the computing devices of the remote network, the computing devices of the local network as having IP addresses with the virtual subnet. In other embodiments, the DNS server replicator peers with a DNS server of the local network and/or a DNS server of the remote network and identifies, to the DNS server of the local network, the computing devices of the remote network as having IP addresses with the virtual subnet, and identifies, to the DNS server of the remote network, the computing devices of the local network as having IP addresses with the virtual subnet.

In some embodiments, the virtual subnet includes the local subnet with at least a portion of the local subnet changed to a different value. In other embodiments, the gateway is a tunnel endpoint of a tunnel connecting the local network with the remote network. In other embodiments, the connecting network is a public network.

In some embodiments, the remote network is a first remote network and a second remote network is connected to computing devices where the computing devices of the local network, the first remote network, and the second remote network each have IP addresses with a same local subnet. The virtual subnet is a first virtual subnet and a second virtual subnet is included. The second virtual subnet is non-overlapping with the local subnet and the first virtual subnet. In the embodiments, the method includes receiving, at the gateway, a first outgoing data packet from the local computing device being sent to a first remote computing device on the first remote network. The first outgoing data packet includes a source IP address with the local subnet and the device ID of the local computing device and a destination IP address includes the first virtual subnet and a device ID of the first remote computing device. In the embodiments, the method includes changing, for the first outgoing data packet, the local subnet of the source IP address to the first virtual subnet and changing the first virtual subnet of the destination IP address to the local subnet, and transmitting the first outgoing data packet to the first remote computing device.

In the embodiments, the method includes receiving, at the gateway, a second outgoing data packet from the local computing device being sent to a second remote computing device on the second remote network. The second outgoing data packet includes a source IP address with the local subnet and the device ID of the local computing device and a destination IP address includes the second virtual subnet and a device ID of the second remote computing device. In the embodiments, the method includes changing, for the second outgoing data packet, the local subnet of the source IP address to the second virtual subnet and changing the second virtual subnet of the destination IP address to the local subnet, and transmitting the second outgoing data packet to the second remote computing device.

An apparatus for connecting services between a remote network and a local network includes a network ID module configured to determine that a local network and a remote network have a same local subnet, and in response to determining that the local network and remote network comprise the same local subnet, to create a virtual subnet. The virtual subnet is non-overlapping with the local subnet. The apparatus includes a DNS server replicator configured to peer with a DNS server of the local network and/or a DNS server of the remote network and to identify, to the DNS server of the local network, computing devices of the remote network as having IP addresses with the virtual subnet, and to identify, to the DNS server of the remote network, computing devices of the local network as having IP addresses with the virtual subnet. The DNS server of the local network identifies, to the computing devices of the local network, the computing devices of the remote network as having IP addresses with the virtual subnet, and identifies, to the computing devices of the remote network, the computing devices of the local network as having IP addresses with the virtual subnet. At least a portion of the modules comprise one or more of hardware circuits, programmable hardware circuits and executable code. The executable code is stored on one or more computer readable storage media.

In some embodiments, the apparatus includes a packet receiver module configured to receive, at a gateway, an outgoing data packet from a local computing device connected to the local network. The outgoing data packet is being sent to a remote computing device on the remote network connected to the local network over a connecting network. The outgoing data packet includes a source IP address with the local subnet and a device ID of the local computing device and a destination IP address includes a virtual subnet and device ID of the remote computing device. In the embodiments, the apparatus includes a virtual address module configured to change the local subnet of the source IP address of the outgoing data packet to the virtual subnet and to change the virtual subnet of the destination IP address to the local subnet, and a transmission module configured to transmit the outgoing data packet to the remote computing device.

In other embodiments, the packet receiver module is further configured to receive an incoming data packet being transmitted to the local computing device from the remote computing device. The incoming data packet includes a source IP address with the local subnet and a destination IP address with the virtual subnet. In the embodiments, the virtual address module is further configured to change the local subnet of the source IP address to the virtual subnet and to change the virtual subnet of the destination IP address to the local subnet, and the transmission module is further configured to transmit the incoming data packet to the local computing device.

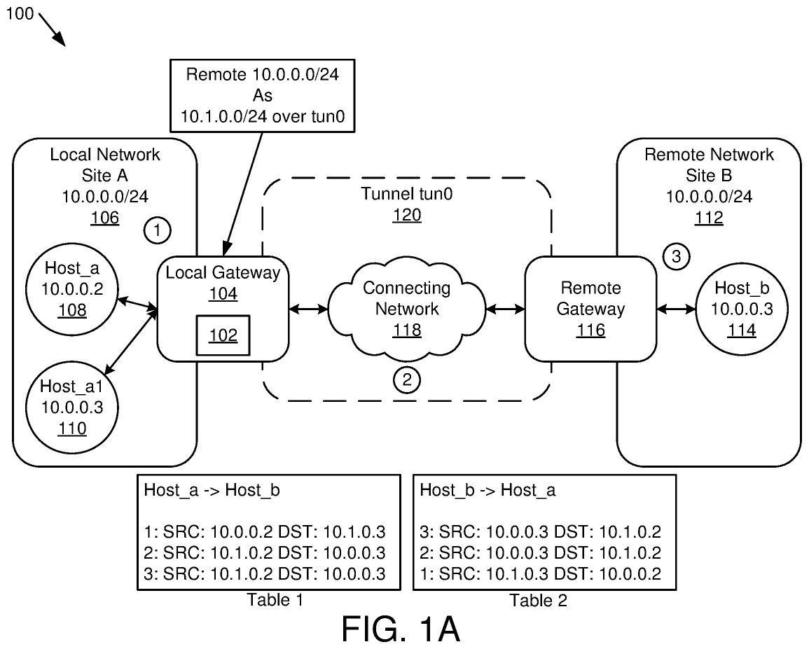

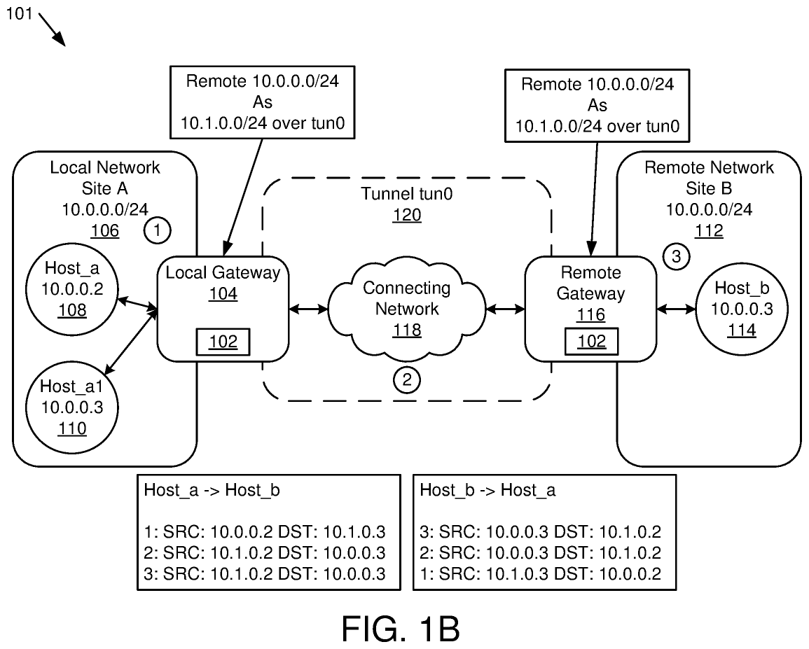

FIG. 1A is a schematic block diagram illustrating a system 100 with a local network at site A 106 and a remote network at site B 112 with overlapping IP addresses (e.g., 10.0.0.0/24) and a local gateway 104 with a translation apparatus 102 for connecting services between the remote network and the local network, according to various embodiments. (Local network 106 and site A 106 as well as remote network 112 and site B 112 are used interchangeably herein.) Note that “local network” and “remote network” are used herein for convenience to distinguish between the two networks 106, 112 and “local” and “remote” are not intended to convey any actual distance, relationship, ownership, etc. In some embodiments, the local network 106 and remote network 12 are private networks with IP addresses separate from a connecting network 118. In some embodiments, the connecting network 118 is a public network, a wide area network, a fiber network, etc. and may include a combination of networks. In some embodiments, the connecting network 118 includes the Internet.

The local network 106 is connected to the connecting network 118 via a local gateway 104. In some embodiments, the local gateway 104 includes a router and has an IP address for the local gateway 104 known to the connecting network 118 and data packets sent to a device in the local network 106 include the IP address of the local gateway 104 along with a destination IP address of a computing device at site A 106, such as host_a 108. In some embodiments, the local gateway 104 serves to decapsulate data packets destined for a computing device of the local network 106 before transmitting the data packet to the computing device. Likewise, the local gateway 104, in some embodiments, serves to encapsulate data packets from a computing device of the local network 106 for transport across the connecting network 118 to some destination device. In some embodiments, the local gateway 104 includes a firewall. In some embodiments, the remote gateway 116 includes the same functions as the local gateway 104, but for the remote network 112. One of skill in the art will recognize other functions, options, capabilities, etc. for the local gateway 104 and the remote gateway 116.

In some situations, two networks (e.g., local network 106 and remote network 112) are connected by some connecting network 118 while the two networks have overlapping IP addresses, which creates a problem when transmitting data between the two networks 106, 112. For example, as depicted in FIG. 1A, host_a1 110 on the local network 106 may have a same IP address 10.0.0.3 as host_b on the remote network 112 so that a data packet from host_a 108 intended for host_b 114 would not be transmitted to host_b 114. In some examples, host_a 104 transmitting a data packet to a destination IP address of 10.0.0.3 would broadcast the data packet so that the data packet would reach the devices in the local network 106 and the local gateway 104. In some embodiments, the local gateway 104 would determine that the destination IP address has a subnet that is the same as the subnet of the local network 106 and would ignore the data packet. The local network 106 would then route the data packet to host_a1 110, even if the intended destination is host_b 114 on the remote network 112. The translation apparatus 102 solves this problem, as explained below.

The local network 106 and the remote network 112 each include various computing devices, such as host_a 108, host_a1 110, and host_b 114. The computing devices may be servers, workstations, rack-mounted servers, desktop computers, laptop computers, tablet computers, printers, switches, storage devices, or any other computing device that may be connected to a network. The local network 106, and the remote network 112, in some embodiments, are private networks and, in some embodiments, the computing devices may be assigned IP addresses within a range. Where the IP addresses of the local network 106 and the remote network 112 have overlapping IP addresses, the translation apparatus 102 is able to allow the IP addresses in both networks 106, 112 to remain without being changed.

Typically, the computing devices each are assigned an IP address. IP addresses a number of bits that depend on the protocol used. For example, Internet Protocol version 4 (“IPv4”) includes 32-bit IP addresses while Internet Protocol version 6 (“IPv6”) includes 128-bit IP addresses. In some embodiments, IP addresses are represented using the Classical Inter-Domain Routing (“CIDR”) format, which is principally a bitwise, prefix-based standard used to represent IP addresses and their routing properties. CIDR facilitates routing by allowing blocks of addresses to be grouped into single routing table entries. The groups, which are known as CIDR blocks, share an initial sequence of bits in a binary representation of their IP addresses. For example, IPv4 CIDR blocks are identified using a syntax similar to IPv4 addresses, which include a dotted-decimal address followed by a slash and a number from 0 to 32, which may be in the form of a.b.c.d/n. The dotted decimal portion is the IP address while the number after the slash indicates a size of a common prefix that is common for computing devices within a network. The remaining bits include a range of numbers. A computing device within the network is assigned one of the numbers in the range.

In some embodiments, the common prefix is called a subnet and the bits in the range after the prefix make up a device identifier (“ID”). For example, an IPv4 address of the form a.b.c.d/24 includes the first 24 bits of an IPv4 address prefix while the remaining 8 bits allow up to 256 unique addresses, which may be suitable for a small network. An IPv4 address for the form a.b.c.d/16 has a 16-bit prefix with 16 bits at the end of the IPv4 address, which allows up to 65,536 unique addresses. For the local network 106 and the remote network 112, each has a subnet of the form a.b.c.d/24 and the local subnet is 10.0.0. The last number (e.g., the “d” in 10.0.0.d) aligns with a device ID. For example, the IP address of host_a 108 is 10.0.0.2 so 10.0.0 is the subnet and “2” is the device ID. FIG. 1A depicts the remote network 112 with the same 10.0.0 subnet and the device ID of host_b 114 (e.g., 3) matches the device ID of host_a1 110 of the local network 106.

In some embodiments, sent data packets from the local network 106 to the remote network 112 and vice versa are transmitted via a tunnel 120, which is depicted in FIG. 1A as tun0. In some embodiments, the tunnel 120 may be called a data tunnel uses a tunneling protocol and provides a secure way to transmit a data packet from one network to another. In various embodiments, the tunnel 120 may use one of a variety of tunneling protocols, such as Virtual Extensible LAN (“VXLAN”), Internet Protocol Security (“IPsec”), a Virtual Private Network (“VPN”) protocol, or the like. Typically, a tunneling protocol allows private network communications to be sent across a public network, such as the Internet, using encapsulation. Typically, a data packet is encapsulated and then transmitted to another network, where the data packet is decapsulated and transmitted on a local network to a final destination. In some embodiments, the data packet is encrypted before encapsulation, and at the end of the tunnel the data packet is decapsulated and then decrypted before transmission to the final destination. In some embodiments, a gateway, router, etc. serves as a starting point and/or ending point for the tunnel. In the embodiments, depicted in FIG. 1A, the local gateway 104 and the remote gateway 116 are endpoints for the tunnel 120.

Note that there are various reasons why two networks, such as local network 106 and remote network 112 have overlapping IP addresses with a same subnet. In some examples, the owner of a first network that provides services may acquire a company that provides other complimentary services provided over a second network where both networks have the same subnet. In other situations, various private networks may use common IP addresses that are simple rather than searching for a unique subnet to use. Generally, data packets are transferred between private networks by using one or more public IP addresses associated with each private network or gateway serving the private network. However, when tunneling is involved, data packets may be encapsulated and/or encrypted prior to entering the tunnel where the local IP addresses for the private networks are used as source and destination IP addresses. In such situations where the private networks have a same subnet, the translation apparatus 102 may be used to successfully transfer data packets through a tunnel 120 between the networks 106, 112.

The translation apparatus 102, in some embodiments, is configured to receive, at the local gateway 104, an outgoing data packet from a local computing device, such as host_a 108. The data packet is being sent to a remote computing device on the remote network 112, such as host_b 114 where the remote network 112 is connected to the local network 106 via a connecting network 118. The computing devices of the local network 106 and the remote network 112 have IP addresses for the computing devices that share a same local subnet (e.g., 10.0.0). The outgoing data packet includes a source IP address with the local subnet 10.0.0 and a device ID (e.g., 2) and a destination IP address with a virtual subnet (e.g., 10.1.0) and the device ID (e.g., 3). The translation apparatus 102 changes the local subnet 10.0.0 of the source IP address to the virtual subnet 10.1.0 and changes the virtual subnet 10.1.0 of the destination IP address to the local subnet 10.0.0 and transmits the data packet to the computing device, host_b 114, of the remote network 112.

In other embodiments, the translation apparatus 102 receives an incoming data packet from a computing device (e.g., host_b 114) of the remote network 112 that is destined for a computing device (e.g., host_a 108) of the local network 106. The incoming data packet includes a source IP address with the local subnet 10.0.0 and a destination IP address with the virtual subnet 10.1.0 and the translation apparatus 102 changes the local subnet 10.0.0 of the source IP address of the incoming data packet to the virtual subnet 10.1.0 and changes the virtual subnet 10.1.0 of the destination IP address of the incoming data packet to the local subnet 10.0.0 and transmits the incoming data packet to host_a 108. Note that use of “outgoing” data packet and “incoming” data packet are used merely for convenience in identifying a direction of data packets for the figures described herein and are not intended to convey any meaning regarding location, ownership, etc. of various networks.

Prior art approaches for networks with overlapping IP addresses are not as efficient as embodiments described herein. Prior art approaches take the approach of assigning a first set of virtual IP addresses for each computing device in a first network and then assigning a second set of virtual IP addresses for each computing device in a second network so that two ranges of IP addresses are needed, which is inefficient.

FIG. 1A includes a “1” in a circle in the local network 106, a “2” in a circle near the connecting network 118, and a “3” in a circle in the remote network 112, which correlate with the tables at the bottom of FIG. 1A. Table 1 on the left indicates source and destination IP addresses for an outgoing data packet sent from host_a 108 to host_b 114 from the perspective of devices at points 1, 2 and 3. Line 1 of table 1 indicates the source and destination IP addresses for the outgoing data packet as it travels from host_a 108 to the local gateway 104. From the perspective of the local network 106, the subnet of the local network 106 is the local subnet 10.0.0 and the subnet of the remote network 112 is the virtual subnet 10.1.0 even though the local subnet of the physical IP addresses for computing devices of the remote network 112 are 10.0.0. Likewise, from the perspective of the remote network 112, the subnet of the remote network 112 is the local subnet 10.0.0 and the subnet of the local network 106 is the virtual subnet 10.1.0 even though the local subnet of the physical IP addresses for computing devices of the local network 106 are 10.0.0.

Thus, the source IP address of the first line (correlating to devices near the circled 1) of Table 1 is 10.0.0.2, and the destination IP address in the first line of Table 1 is 10.1.0.3. The translation apparatus 102 changes the source IP address of the outgoing data packet to 10.1.0.2 so that the remote network 112 knows that the outgoing data packet, when received at the remote network 112 is from the local network 106. The translation apparatus 102 changes the destination IP address of the outgoing data packet to 10.0.0.3, which is the physical address of host_b 114 so that the local gateway 104 properly transmits the outgoing data packet to host_b 114. Line 2 correlates to devices near the circled 2 and represents the perspective of the tunnel 120 and line 3 represents the perspective of the remote network 112, near the circled 3. After translation of the IP addresses by the translation apparatus 102, the outgoing data packet, from the perspective of the tunnel 120, connecting network 118, and the remote network 112, comes from the local network 106 with a subnet of 10.1.0 and is going to the remote network 112 having a subnet of 10.0.0.

Table 2 is for an incoming data packet coming from host_b 114 and going to host_a 108. Lines 3 and 2 depict the source IP address as 10.0.0.3 and the destination IP address as 10.1.0.2, which is from the perspective of the remote network 112, the tunnel 120, and the connecting network 118. Line 1 at the bottom of Table 2 is after the translation apparatus 102 has changed the source IP address from 10.0.0.3 to 10.1.0.3 and the destination IP address from 10.1.0.2 to 10.0.0.2 so that the incoming data packet is properly transmitted to host_a 108.

The local network 106, the remote network 112, and the connecting network 118, in various embodiments, are implemented as a LAN, a WAN, a fiber network, a wireless network, or any combination thereof. The local network 106, the remote network 112, and the connecting network 118 include various networking devices, such as routers, switches, servers, etc. and associated cabling. In some embodiments, the connecting network 118 includes a public network and may include the Internet. In some embodiments, the local network 106 and the remote network 112 are private networks.

The wireless network may be a mobile telephone network. The wireless network may also employ a Wi-Fi network based on any one of the Institute of Electrical and Electronics Engineers (“IEEE”) 802.11 standards. Alternatively, the wireless network may be a BLUETOOTH® connection. In addition, the wireless network may employ a Radio Frequency Identification (“RFID”) communication including RFID standards established by the International Organization for Standardization (“ISO”), the International Electrotechnical Commission (“IEC”), the American Society for Testing and Materials® (“ASTM” ®), the DASH7™ Alliance, and EPCGlobal™.

Alternatively, the wireless network may employ a ZigBee® connection based on the IEEE 802 standard. In one embodiment, the wireless network employs a Z-Wave® connection as designed by Sigma Designs®. Alternatively, the wireless network may employ an ANT® and/or ANT+® connection as defined by Dynastream® Innovations Inc. of Cochrane, Canada.

The wireless network may be an infrared connection including connections conforming at least to the Infrared Physical Layer Specification (“IrPHY”) as defined by the Infrared Data Association® (“IrDA” ®). Alternatively, the wireless network may be a cellular telephone network communication. All standards and/or connection types include the latest version and revision of the standard and/or connection type as of the filing date of this application.

FIG. 1B is a schematic block diagram illustrating a system 101 with a local network 106 and a remote network 112 with overlapping IP addresses and a local gateway 104 and a remote gateway 116 each with a translation apparatus 102 for connecting services between the remote network 112 and the local network 106, according to various embodiments. In the embodiments of FIG. 1B, both translation apparatuses 102 carry out the translations described above in relation to the system 100 of FIG. 1A, and may coordinate. In some embodiments, the translation apparatus 102 of the local gateway 104 processes data packets from the local network 106 to the remote network 112 while the translation apparatus 102 of the remote gateway 116 processes data packets sent from the remote network 112 to the local network 106. In other embodiments, one translation apparatus 102 may act as the primary (e.g., master) and may process all data packets while the other translation apparatus 102 does nothing until failure of the primary translation apparatus 102. One of skill in the art will recognize how translation apparatuses 102 in various gateways coordinate.

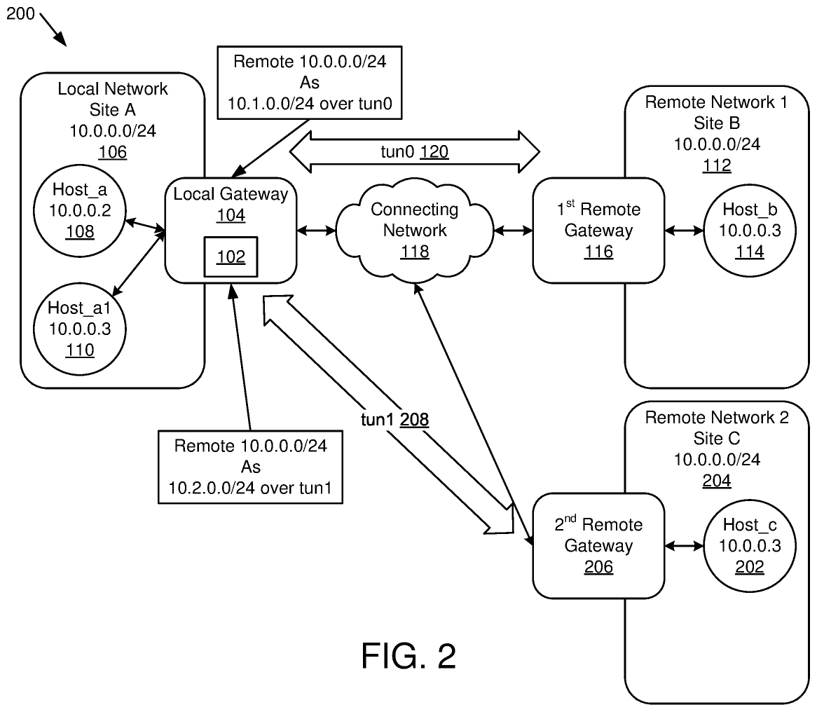

FIG. 2 is a schematic block diagram illustrating a system 200 with a local network 106 and two remote networks 112, 204 with overlapping IP addresses and a local gateway 104 with a translation apparatus 102 for connecting services between the two remote networks 112, 204 and the local network 106, according to various embodiments. In the embodiments of FIG. 2, the system 200 includes a local gateway 104 with a translation apparatus 102, a local network 106 (site A 106), a host_a 108, a host_a1 110, a first remote network 112 with host_b 114, a first remote gateway 116, a connecting network 118, and a tunnel tun0 120, which are substantially similar to those describe above in relation to the systems 100, 101 of FIGS. 1A and 1B. The system 200 of FIG. 2 includes a second remote network 204 (site C 204) with a host_c 202 connected to the local network 106 over the connecting network 118, which may also include a tunnel tun1 208. The local network 106, the first remote network 112, and the second remote network 204 all have overlapping local subnets 10.0.0.

Transmission of an outgoing data packet from a computing device on the local network 106, such as host_a 108, to a computing device, such as host_c 202, of the second remote network 204 includes translation of source and destination IP addresses by the translation apparatus 102 except that the virtual subnet used for the second remote network 204 is 10.2.0 instead of 10.1.0. Where there are additional networks with a subnet that overlap with the local network 106, the first remote network 112, and the second remote network 204, the translation apparatus 102 would use additional virtual addresses. While the translation apparatus 102 is depicted only in the local gateway 104 in FIG. 2, other remote gateways 116, 206 may also have a translation apparatus 102, which would allow data packet transmission between the first remote network 112 and the second remote network 204 using a third virtual subnet, such as 10.3.0. In addition, data packets being transmitted between the first remote network 112 and the second remote network 204 may include use of a third tunnel (not shown) between the first remote gateway 116 and the second remote gateway 206.

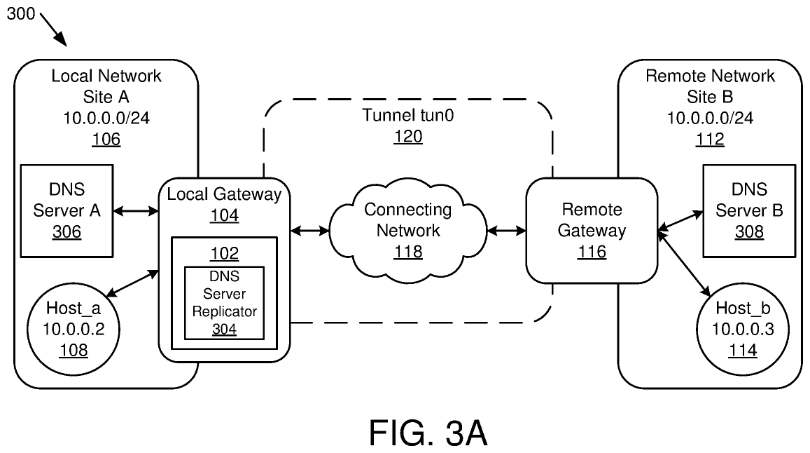

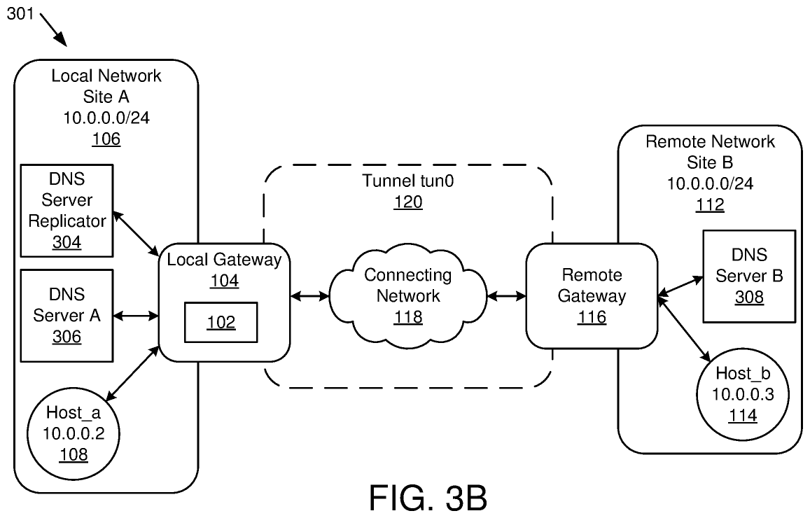

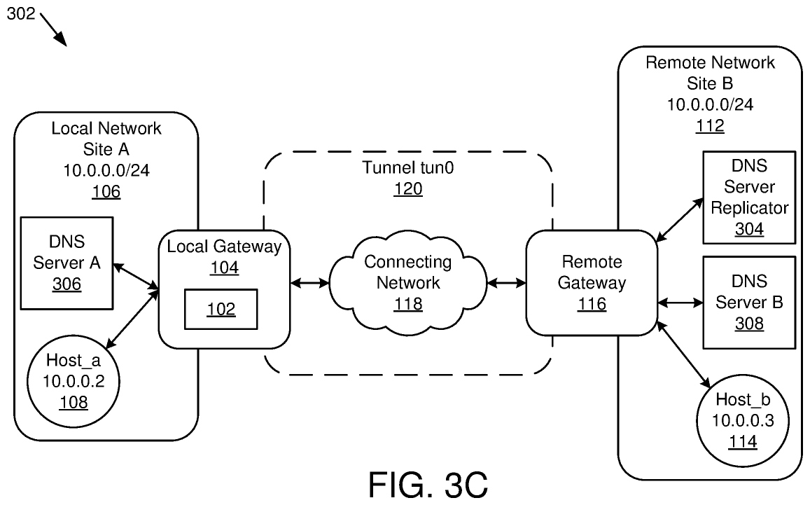

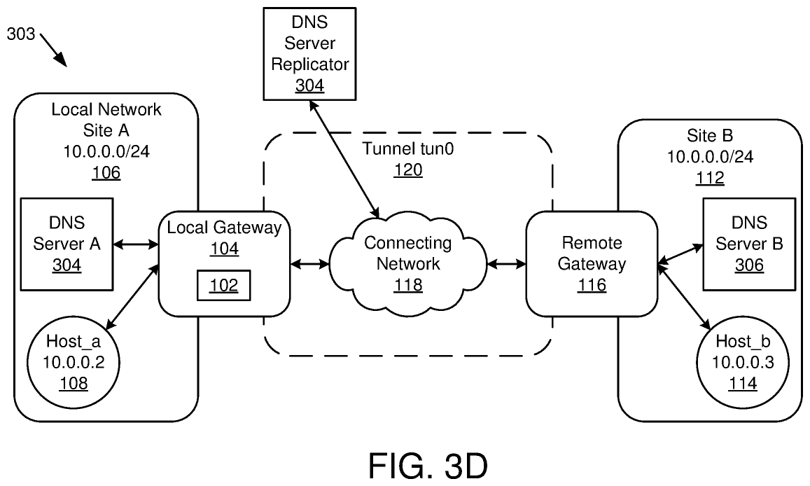

FIG. 3A is a schematic block diagram illustrating a system 300 with a local network 106 and a remote network 112 with overlapping IP addresses and a local gateway 104 with a translation apparatus 102 for connecting services between the remote network 112 and the local network 109 where the translation apparatus 102 includes a Domain Name System (“DNS”) server replicator 304, according to various embodiments. In the embodiments of FIG. 3, the system 300 includes a local gateway 104 with a translation apparatus 102, a local network 106 (site A 106), a host_a 108, a host_a1 110, a remote network 112 with host_b 114, a remote gateway 116, a connecting network 118, and a tunnel tun0 120, which are substantially similar to those describe above in relation to the systems 100, 101, 200 of FIGS. 1A, 1B, and 2. The system 300 includes a DNS server replicator 304, a DNS server A 306 in the local network 106, and a DNS server B 308 in the remote network 112, which are described below.

The Domain Name System (“DNS”) is a hierarchical and distributed naming system for computing devices and other Internet resources or other IP networks. DNS associates various information with domain names assigned to each associated entity. Most prominently, DNS translates domain names to IP addresses assigned to the domain names to locate and identify computing devices and services associated with the domain names. Often, DNS servers are distributed throughout various networks and communicate with each other as peers, and a computing device seeking a to access services associated with a domain name communicate with a local DNS server to get an IP address of the sought for domain name. The computing device will then use the associated IP address when a user is seeking services associated with the domain name to then transmit information to the computing device assigned to the IP address.

In the embodiments of FIG. 3A, DNS server A 306 services the local network 106 and would store an association between “host_a” and the assigned IP address 10.0.0.2 in a table or other data structure. For the system 100 of FIG. 1A, DNS server A 306 would associate “host_a1” with 10.0.0.3. DNS server A 306 would include an association for a label for each computing device of the local network 106 and an associated IP address. In addition, DNS server A 306 would include an IP address of the local gateway 104 and a name for the local gateway 104, such as “gateway 1.” In some embodiments, the local gateway 104 has an IP address known to the computing devices in the local network 106 and another IP address known to computing devices connected to the connecting network 118. DNS server A 306 may also include IP addresses and associated domain names, or other identifiers for other computing devices beyond the local gateway 104.

DNS server B 308 would associate “host_b” with 10.0.0.3, and would include other associations between names, domain names, etc. of computing devices of the remote network 112 and IP addresses of the computing devices. DNS server B 308 may associate the IP address of the remote gateway 116 and a name, such as “gateway 2.” The remote gateway 116 may also have an IP address with the local subnet known to computing devices of the remote network 112 and another IP address known to computing devices connected to the connecting network 118. Again, DNS server B 308 may also include IP addresses and associated domain names, or other identifiers for other computing devices beyond the remote gateway 116. The computing devices of the local network 106 and the remote network 112 would communicate with the respective DNS servers A and B 304, 306 to get an IP address associated with a server name, domain name, host name, etc.

The DNS server replicator 304 is configured to act as an intermediary between DNS server A 306 and the computing devices of the remote network 112 and as an intermediary between DNS server B 308 and the computing devices of the local network 106. In some embodiments, the DNS server replicator 304 peers with DNS server A 306 and DNS server B 308 to identify, to DNS server A 306, the computing devices of the remote network 112 as having IP addresses with the virtual subnet 10.1.0, and to identify, to DNS server B 308, the computing devices of the local network 106 as having IP addresses with the virtual subnet 10.1.0. Details of the DNS server replicator 304 are discussed in more detail below with respect to the apparatus 500 of FIG. 5.

FIG. 3B is a schematic block diagram illustrating a system 301 with a local network 106 and a remote network 112 with overlapping IP addresses and a local gateway 104 with a translation apparatus 102 for connecting services between the remote network 112 and the local network 106 where the local network 106 (or local site A 106) includes a DNS server replicator 304, according to various embodiments. In the embodiments, the DNS server replicator 304 operates in the same way as the DNS server replicator 304 of FIG. 3A. In the embodiments, DNS server B 308 also communicates with the DNS server replicator 304.

FIG. 3C is a schematic block diagram illustrating a system 302 with a local network 106 and a remote network 112 with overlapping IP addresses and a local gateway 104 with a translation apparatus 102 for connecting services between the remote network 112 and the local network 106 where the remote network 112 (e.g., remote site B 112) includes a DNS server replicator 304, according to various embodiments. In the embodiments of FIG. 3C, the DNS server replicator 304 is at site B 112, but is still in communication with DNS server A 306.

FIG. 3D is a schematic block diagram illustrating a system 303 with a local network 106 and a remote network 112 with overlapping IP addresses and a local gateway 104 with a translation apparatus 102 for connecting services between the remote network 112 and the local network 106 where a connecting network 118 is connected to a DNS server replicator 304, according to various embodiments. Again, the DNS server replicator 304 is in communication with DNS server A 306 and DNS server B 308. In some embodiments, the connecting network 118 is a public network and the DNS server replicator 304 may include a public IP address and may server other networks.

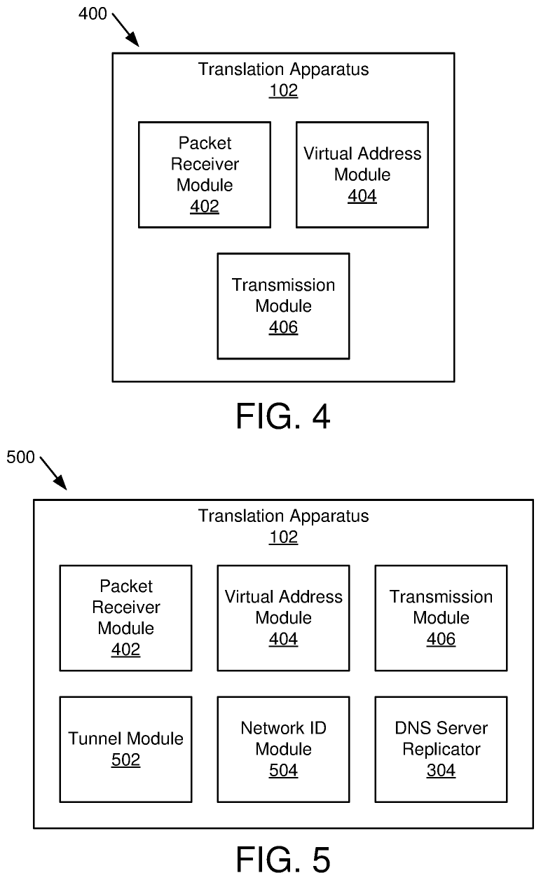

FIG. 4 is a schematic block diagram illustrating an apparatus 400 for connecting services between a remote network 112 and a local network 106 with overlapping IP addresses, according to various embodiments. The apparatus 400 includes a translation apparatus 102 with a packet receiver module 402, a virtual address module 404, and a transmission module 406, which are described below. In some embodiments, the apparatus 400 is implemented with executable code stored on non-transitory computer readable storage media, such as on a non-volatile storage device of a gateway (e.g., local gateway 104), router, etc. connecting a local network 106 or remote network 112 to a connecting network 118. In other embodiments, all or a portion of the apparatus 400 are implemented with hardware circuits and/or a programmable hardware device.

The apparatus 400 includes a packet receiver module 402 configured to receive, at a gateway (e.g. local gateway 104), an outgoing data packet from a local computing device (e.g., host_a 108) connected to a local network 106. The outgoing data packet is being sent to a remote computing device (e.g., host_b 114) on a remote network 112 connected to the local network 106 over a connecting network 118. The apparatus 400 is applicable where computing devices of the local network 106 have IP addresses with a local subnet (e.g., 10.0.0) matching a local subnet (e.g., 10.0.0) of IP addresses of computing devices of the remote network 112 and data packets are transmitted between the local network 106 and the remote network 112, and may be transmitted via a tunnel 120. The outgoing data packet, for example being transmitted from host_a 108 includes a source IP address with the local subnet 10.0.0 and a device ID of the local computing device (e.g. “3”) and a destination IP address with a virtual subnet (e.g., 10.1.0) and a device ID of the remote computing device (e.g., 2″). The virtual subnet 10.1.0 is non-overlapping with the local subnet 10.0.0, such as when the virtual subnet 10.1.0 is not the same as the local subnet 10.0.0.

In some embodiments, when the outgoing data packet is destined for another computing device with an IP address that does not have an IP address with a same subnet of 10.0.0, the outgoing data packet is processed normally without processing by the apparatus 400. Note that “local” and “remote” are merely for convenience in distinguishing between the two networks 106, 112 with overlapping IP addresses that are connected by the connecting network 118. The apparatus 400 is applicable to any two networks connected by a connecting network 118, a public network, etc. where the two networks have overlapping IP addresses. Note also that the IP address discussed herein are of the form a.b.c.d/24, but the apparatus 400 is applicable for any size subnet. While the local subnet is 10.0.0 in embodiments described herein, one of skill in the art will recognize that the apparatus 400 is applicable to any subnet and associated virtual subnet.

In some embodiments, the virtual subnet is the same as the local subnet but has a portion of the local subnet modified to create the virtual subnet. In embodiments described herein, the virtual subnet is created by merely changing the “0” in the second field (i.e., the “b” field in an a.b.c.d/n format) to a “1.” In other embodiments, the “a” field or the “c” field are modified for IP addresses of the form a.b.c.d/24. In other embodiments, more than one field is modified. In other subnet form, appropriate changes are made to a local subnet. One of skill in the art will recognize other ways to modify a local subnet to get a virtual subnet or to come up with a different subnet.

The apparatus 400 includes a virtual address module 404 configured to change the local subnet (e.g., 10.0.0) of the source IP address of the outgoing data packet to the virtual subnet (e.g., 10.1.0) and changing the virtual subnet (e.g., 10.1.0) of the destination IP address to the local subnet (e.g., 10.0.0). From the perspective of a computing device (e.g., host_a 108) of the local network 106, the computing device (e.g., host_b 114) of the remote network 112 has an IP address that includes the virtual subnet (e.g., 10.1.0), which enables data packets being sent to the remote network 112 to be processed by the local gateway 104 instead of being dropped, even though the actual IP address of the remote computing device has a same local subnet as the local subnet of the local network 106. In some embodiments, the virtual address module 404 generates the virtual subnet.

Once the virtual address module 404 changes the destination IP address of the outgoing data packet from the virtual subnet to the local subnet, the local gateway 104 is able to transmit the outgoing data packet to the proper computing device in the remote network 112. Also, once the virtual address module 404 changes the source IP address of the outgoing data packet from the local subnet to the virtual subnet, the computing device connected to the remote network 112 will know that the outgoing data packet is from the computing device (e.g., host_a 108) from the local network 106.

The apparatus 400 includes a transmission module 406 configured to transmit the outgoing data packet to the remote computing device (e.g., host_b 114) of the remote network 112. In some embodiments, the transmission module 406 transmits the outgoing data packet via a tunnel 120. The outgoing data packet at the time of transmission will have a source IP address with the virtual subnet (e.g., 10.1.0) and a destination IP address with the local subnet (e.g., 10.0.0).

For data packets from a computing device (e.g., host_b 114) of the remote network 112, the packet receiver module 402 is further configured to receive an incoming data packet being transmitted to the local computing device (e.g., host_a 108) from the remote computing device (e.g., host_b 114). The incoming data packet includes a source IP address with the local subnet (e.g., 10.0.0) and a destination IP address with the virtual subnet (e.g., 10.1.0). Also, the virtual address module 404 is further configured to change the local subnet (e.g., 10.0.0) of the source IP address to the virtual subnet (e.g., 10.1.0) and to change the virtual subnet (e.g., 10.1.0) of the destination IP address to the local subnet (e.g., 10.0.0) and the transmission module 406 is further configured to transmit the incoming data packet to the local computing device (e.g., host_a 108). From the perspective of a computing device at the remote network 112, computing devices of the local network 106 have IP addresses with a virtual subnet (e.g., 10.1.0). Note that the local subnet 10.0.0 and virtual subnet 10.1.0 are merely examples and other local and virtual subnets may be used for any subnet size.

FIG. 5 is a schematic block diagram illustrating another apparatus 500 for connecting services between a remote network 112 and a local network 106 with overlapping IP addresses, according to various embodiments. The apparatus 500 includes another translation apparatus 102 with a packet receiver module 402, a virtual address module 404, and a transmission module 406, which are substantially similar to those of the apparatus 400 of FIG. 4. In various embodiments, the apparatus 500 includes a tunnel module 502, a network ID module 504, and/or a DNS server replicator 304, which are described below. In some embodiments, the apparatus 500 is implemented similar to the apparatus 400 of FIG. 4. Some or all of the modules 402, 404, 406, 502, 504 and the DNS server replicator 506 may be located elsewhere. Alternate locations of the DNS server replicator 304 are depicted in FIGS. 3A-3D.

In some embodiments, data packets transmitted over the connecting network 118 are transmitted via a tunnel 120 and the apparatus 500 includes a tunnel module 502 configured to encapsulate, based on a tunnel protocol of the tunnel 120, and/or encrypt outgoing data packets in response to the virtual address module changing the source IP address and the destination IP address of the outgoing data packets and the transmission module 406 transmits the encapsulated and/or encrypted outgoing data packets via the tunnel 120. In other embodiments, the tunnel module 502 is configured to decapsulate, based on the tunnel protocol, and/or decrypt incoming data packets received from the packet receiver module 402. In the embodiments, the virtual address module 404 changes the source IP address and the destination IP address in response to the tunnel module 502 decapsulating and/or decrypting the incoming data packets.

In some embodiments, the tunnel module 502 uses a tunneling protocol, such as IPsec, VXLAN, etc. or a VPN tunneling protocol. In other embodiments, apparatus 500 does not include the tunnel module 502 and the transmission module 406 inputs outgoing data packets to an existing tunnel, such as tunnel tun0 120 and the tunnel tun0 120 encapsulates and/or encrypts the outgoing data packets before transmission. In other embodiments, the packet receiver module 402 receives a decapsulated and/or decrypted incoming data packet from the tunnel 120.

In some embodiments, the apparatus 500 includes a network ID module 504 configured to determine that a local network 106 and a remote network 112 (or any other two networks) have the same local subnet (e.g., 10.0.0). Computing devices of the two networks seek to communicate with each other. The network ID module 504, in response to determining that the local network 106 and remote network 112 have the same local subnet, create the virtual subnet (e.g., 10.1.0). In some embodiments, the network ID module 504 creates the virtual subnet (e.g., 10.1.0) by modifying a portion of the local subnet (e.g., 10.0.0) to create the virtual subnet (e.g., changing the second field of the local subnet from “0” to “1”).

In other embodiments, the network ID module 504 reports the networks that have the same subnet and transmits the virtual subnet to the DNS server replicator 304 and/or to other modules 402-406, 502 of the translation apparatus 102. For example, in some embodiments, the packet receiver module 402 may only receive incoming or outgoing data packets being transmitted between two networks 106, 112 with the same local subnet while allowing other data packets to be processed separately by the gateway (e.g., local gateway 104 and/or remote gateway 116).

In some embodiments, the apparatus 500 includes a DNS server replicator 304 configured to peer with a DNS server of the local network 106, such as DNS server A 306, and/or a DNS server of the remote network 112, such as DNS server B 308, and configured to identify, to the DNS server of the local network 106, the computing devices of the remote network 112 as having IP addresses with the virtual subnet, and configured to identify, to the DNS server of the remote network 112, the computing devices of the local network 106 as having IP addresses with the virtual subnet. The DNS server replicator 304 peers with DNS servers of the local network 106 and remote network 112 by communicating with the DNS servers and coordinating when to use a subnet in place of a local subnet.

In some embodiments, the DNS server replicator 304 is configured to identify, to the computing devices of the local network 106, the computing devices of the remote network 112 as having IP addresses with the virtual subnet, and to identify, to the computing devices of the remote network 112, the computing devices of the local network 106 as having IP addresses with the virtual subnet. In some examples, the DNS server replicator 304 is combined with a DNS server and directly identifies, to the computing devices of the local network 106, the computing devices of the remote network 112 as having IP addresses with the virtual subnet, and directly identifies, to the computing devices of the remote network 112, the computing devices of the local network 106 as having IP addresses with the virtual subnet. In other embodiments, the DNS server replicator 304 works through the DNS servers of the local network 106 and the remote network 112.

In some embodiments, the DNS server replicator 304 is configured to communicate with the network ID module 504 to determine which networks have a common subnet and to receive an assigned virtual subnet. In other embodiments, the DNS server replicator 304 creates the virtual subnet. In other embodiments, another device creates the virtual subnet, such as the virtual address module 404. As stated with respect to the systems 300, 301, 302, 303 of FIGS. 3A-3D, in various embodiments, the DNS server replicator 304 may be located in various places, networks, etc. Once the computing devices of the local network 106 identify the computing devices of the remote network 112 as having the virtual subnet, the computing devices of the local network 106 are able to create a data packet destined for the remote network 112 with a destination IP address having the virtual subnet and a device ID of the destination computing device. Likewise, once the computing devices of the remote network 112 identify the computing devices of the local network 106 as having the virtual subnet, the computing devices of the remote network 112 are able to create a data packet destined for the local network 106 with a destination IP address having the virtual subnet and a device ID of the destination computing device.

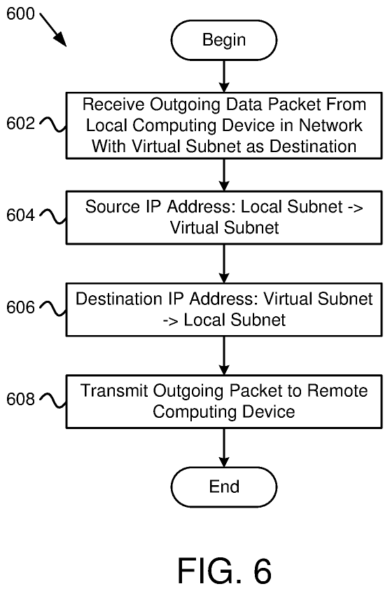

FIG. 6 is a schematic flowchart diagram illustrating a method 600 for transmitting an outgoing data packet from a local network 106 to a remote network 112 with overlapping IP addresses, according to various embodiments. The method 600 begins and receives 602, at a gateway such as the local gateway 104, an outgoing data packet from a local computing device, such as host_a 108, connected to a local network 106. The outgoing data packet is being sent to a remote computing device, such as host_b 114, on a remote network 112 connected to the local network 106 over a connecting network 118. Computing devices of the local network include IP addresses with a local subnet (e.g., 10.0.0) matching a local subnet of IP addresses of computing devices of the remote network 112. The outgoing data packet includes a source IP address with the local subnet and a device ID of the local computing device and a destination IP address with a virtual subnet and device ID of the remote computing device. The virtual subnet (e.g., 10.1.0) is non-overlapping with the local subnet, meaning that that virtual subnet differs from the local subnet.

The method 600 changes 604 the local subnet (e.g., 10.0.0) of the source IP address of the outgoing data packet to the virtual subnet (e.g., 10.1.0) and changes 606 the virtual subnet (e.g., 10.1.0) of the destination IP address to the local subnet (e.g., 10.0.0) and transmits 608 the outgoing data packet to the remote computing device, and the method 600 ends. In various embodiments, all or a portion of the method 600 is implemented using the packet receiver module 402, the virtual address module 404, and/or the transmission module 406.

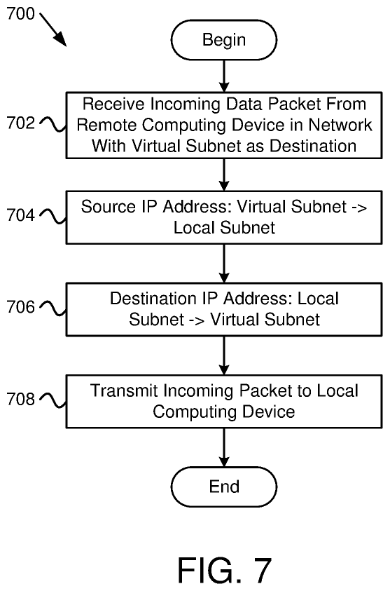

FIG. 7 is a schematic flowchart diagram illustrating a method 700 for transmitting an incoming data packet from a remote network 112 to a local network 109 with overlapping IP addresses, according to various embodiments. The method 700 begins and receives 702, at a gateway such as the local gateway 104, an incoming data packet from a remote computing device, such as host_b 114, connected to a remote network 112. The incoming data packet is being sent to a local computing device, such as host_a 108, on a local network 109 connected to the remote network 112 over a connecting network 118. Computing devices of the local network 109 include IP addresses with a local subnet matching a local subnet of IP addresses of computing devices of the remote network 112. The incoming data packet has a source IP address with the local subnet and a ID of the remote computing device and a destination IP address with a virtual subnet and device ID of the local computing device. The virtual subnet is non-overlapping with the local subnet.

The method 700 changes 704 the local subnet of the source IP address to the virtual subnet and changes 706 the virtual subnet of the destination IP address to the local subnet. The method 700 transmits 708 the incoming data packet to the local computing device, and the method 700 ends. In various embodiments, all or a portion of the method 700 is implemented using the packet receiver module 402, the virtual address module 404, and/or the transmission module 406.

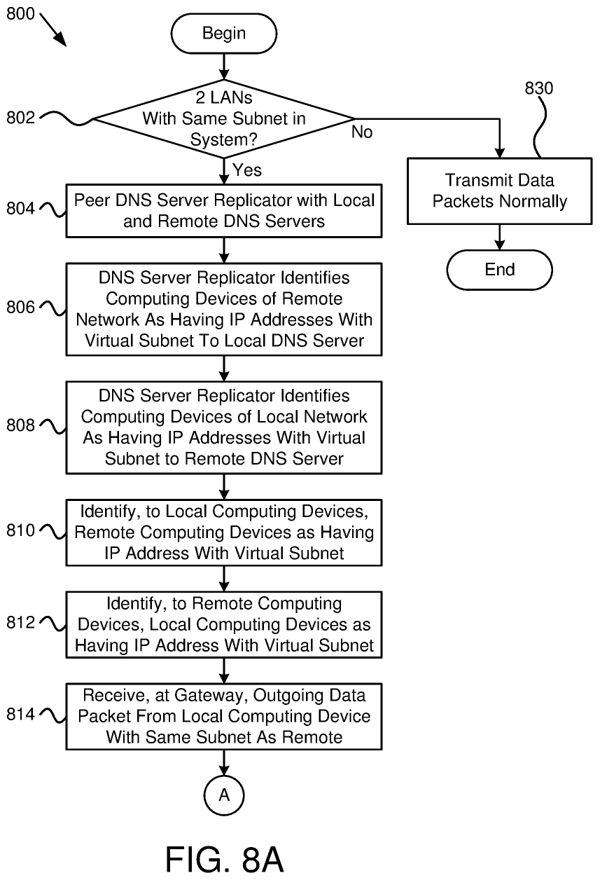

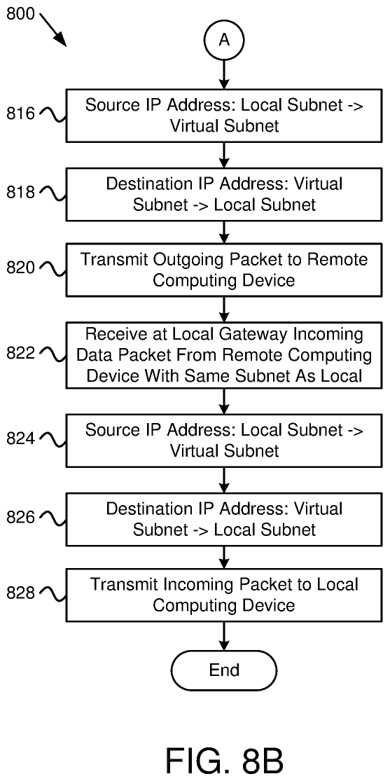

FIG. 8A is a first part and FIG. 8B is a second part of a schematic flowchart diagram illustrating a method 800 for managing IP addresses and data packet transmission for a connected local network 106 and remote network 112 with overlapping IP addresses, according to various embodiments. The method 800 begins and determines 802 if there are two networks (such as the local network 106 and the remote network 112) with computing devices with IP addresses that have a same subnet. If the method 800 determines 802 that there are two networks with computing devices with IP addresses with the same subnet, the method 800 peers 804 a DNS server replicator 304 with DNS servers of the networks, such as DNS server A 306 and DNS server B 308.

The DNS server replicator 304 identifies 806, to the DNS server of the local network 106 (e.g., DNS server A 306), the computing devices of the remote network 112 as having IP addresses with the virtual subnet, and identifies 808, to the DNS server of the remote network 112 (e.g., DNS server B 308), the computing devices of the local network as having IP addresses with the virtual subnet. The method 800, via the local DNS server (e.g., DNS server A 306) identifies 810, to the computing devices of the local network 106, the computing devices of the remote network 112 as having IP addresses with the virtual subnet. The method 800, via the remote DNS server (e.g., DNS server B 308), identifies 812, to the computing devices of the remote network 112, the computing devices of the local network 106 as having IP addresses with the virtual subnet.

The method 800 receives 814 at a gateway, such as the local gateway 104, an outgoing data packet from a local computing device (e.g., host_a 108) connected to the local network 106 being sent to a remote computing device, such as host_b 114, on a remote network 112 connected to the local network 106 over the connecting network 118. The outgoing data packet has a source IP address with the local subnet and a device ID of the local computing device, for example, 10.0.0.2, and a destination IP address has a virtual subnet and device ID of the remote computing device, for example 10.1.0.3. Host_a 108, for example, received the virtual subnet for host_b 114 from DNS server A 306.

The method 800 (follow “A” on FIG. 8A to “A” on FIG. 8B) changes 816 the local subnet of the source IP address of the outgoing data packet to the virtual subnet and changes 818 the virtual subnet of the destination IP address to the local subnet. The method 800 transmits 820 the outgoing data packet to the remote computing device, host_b 114, via a tunnel 120.

The method 800 receives 822, at the gateway (local gateway 104) and via a tunnel 120, an incoming data packet being transmitted to the local computing device, host_a 108, from the remote computing device, host_b 114. The incoming data packet has a source IP address with the local subnet and a destination IP address with the virtual subnet. The method 800 changes 824 the local subnet of the source IP address to the virtual subnet and changes 826 the virtual subnet of the destination IP address to the local subnet. The method 800 transmits 828 the incoming data packet to the local computing device, host_a 104, and the method 800 ends. If the method 800 determines 802 that there are not two networks with computing devices with IP addresses with the same subnet, the method 800 transmits 830 data packets normally, and the method 800 ends. In various embodiments, all or a portion of the method 800 is implemented using the packet receiver module 402, the virtual address module 404, the transmission module 406, the tunnel module 502, the network ID module 504, and/or the DNS server replicator 304.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A apparatus comprising:
a packet receiver module configured to receive, at a gateway, an outgoing data packet from a local computing device connected to a local network, the outgoing data packet being sent to a remote computing device on a remote network connected to the local network over a connecting network, wherein computing devices of the local network comprise internet protocol (“IP”) addresses with a local subnet matching a local subnet of IP addresses of computing devices of the remote network, the outgoing data packet comprising a source IP address with the local subnet and a device identifier (“ID”) of the local computing device and a destination IP address comprising a virtual subnet and device ID of the remote computing device, the virtual subnet non-overlapping with the local subnet;
a virtual address module configured to change the local subnet of the source IP address of the outgoing data packet to the virtual subnet and to change the virtual subnet of the destination IP address to the local subnet; and
a transmission module configured to transmit the outgoing data packet to the remote computing device,
wherein at least a portion of said modules comprise one or more of hardware circuits, programmable hardware circuits and executable code, the executable code stored on one or more computer readable storage media.

2. The apparatus of claim 1, wherein:
the packet receiver module is further configured to receive an incoming data packet being transmitted to the local computing device from the remote computing device, the incoming data packet comprising a source IP address with the local subnet and a destination IP address with the virtual subnet;
the virtual address module is further configured to change the local subnet of the source IP address to the virtual subnet and to change the virtual subnet of the destination IP address to the local subnet; and
the transmission module is further configured to transmit the incoming data packet to the local computing device.

3. The apparatus of claim 2, wherein data packets transmitted over the connecting network are transmitted via a tunnel and further comprising a tunnel module configured to:
encapsulate, based on a tunnel protocol of the tunnel, and/or encrypt the outgoing data packet in response to the virtual address module changing the source IP address and the destination IP address of the outgoing data packet and wherein the transmission module transmits the encapsulated and/or encrypted outgoing data packet via the tunnel, and
decapsulate, based on the tunnel protocol, and/or decrypt the incoming data packet received from the packet receiver module, wherein the virtual address module changes the source IP address and the destination IP address in response to the tunnel module decapsulating and/or decrypting the incoming data packet.

4. The apparatus of claim 1, further comprising a Domain Name System (“DNS”) server replicator configured to:
identify, to the computing devices of the local network, the computing devices of the remote network as having IP addresses with the virtual subnet; and
identify, to the computing devices of the remote network, the computing devices of the local network as having IP addresses with the virtual subnet.

5. The apparatus of claim 4, wherein the DNS server replicator is configured to peer with a DNS server of the local network and/or a DNS server of the remote network and to identify, to the DNS server of the local network, the computing devices of the remote network as having IP addresses with the virtual subnet, and to identify, to the DNS server of the remote network, the computing devices of the local network as having IP addresses with the virtual subnet.

6. The apparatus of claim 1, wherein the virtual subnet comprises the local subnet with at least a portion of the local subnet changed to a different value.

7. The apparatus of claim 1, wherein the gateway is a tunnel endpoint of a tunnel connecting the local network with the remote network.

8. The apparatus of claim 1, wherein the connecting network is a public network.

9. The apparatus of claim 1, wherein the remote network is a first remote network and further comprising a second remote network connected to computing devices, wherein the computing devices of the local network, the first remote network, and the second remote network each have IP addresses with a same local subnet, and wherein the virtual subnet is a first virtual subnet and further comprising a second virtual subnet, the second virtual subnet non-overlapping with the local subnet and the first virtual subnet, and wherein:
the packet receiver module is further configured to receive, at the gateway:
a first outgoing data packet from the local computing device being sent to a first remote computing device on the first remote network, the first outgoing data packet comprising a source IP address with the local subnet and the device ID of the local computing device and a destination IP address comprising the first virtual subnet and a device ID of the first remote computing device; and
a second outgoing data packet from the local computing device being sent to a second remote computing device on the second remote network, the second outgoing data packet comprising a source IP address with the local subnet and the device ID of the local computing device and a destination IP address comprising the second virtual subnet and a device ID of the second remote computing device;
the virtual address module is further configured to:
change, for the first outgoing data packet, the local subnet of the source IP address to the first virtual subnet and change the first virtual subnet of the destination IP address to the local subnet; and
change, for the second outgoing data packet, the local subnet of the source IP address to the second virtual subnet and change the second virtual subnet of the destination IP address to the local subnet; and
the transmission module is further configured to:
transmit the first outgoing data packet to the first remote computing device; and
transmit the second outgoing data packet to the second remote computing device.

10. The apparatus of claim 1, further comprising a network ID module configured to:
determine that the local network and the remote network comprise the same local subnet; and
in response to determining that the local network and remote network comprise the same local subnet, create the virtual subnet.

11. A method comprising:
receiving, at a gateway, an outgoing data packet from a local computing device connected to a local network, the outgoing data packet being sent to a remote computing device on a remote network connected to the local network over a connecting network, wherein computing devices of the local network comprise internet protocol (“IP”) addresses with a local subnet matching a local subnet of IP addresses of computing devices of the remote network, the outgoing data packet comprising a source IP address with the local subnet and a device identifier (“ID”) of the local computing device and a destination IP address comprising a virtual subnet and device ID of the remote computing device, the virtual subnet non-overlapping with the local subnet;
changing the local subnet of the source IP address of the outgoing data packet to the virtual subnet and changing the virtual subnet of the destination IP address to the local subnet; and
transmitting the outgoing data packet to the remote computing device.

12. The method of claim 11, further comprising:
receiving, at the gateway, an incoming data packet being transmitted to the local computing device from the remote computing device, the incoming data packet comprising a source IP address with the local subnet and a destination IP address with the virtual subnet;
changing the local subnet of the source IP address to the virtual subnet and changing the virtual subnet of the destination IP address to the local subnet; and
transmitting the incoming data packet to the local computing device.

13. The method of claim 12, wherein data packets transmitted over the connecting network are transmitted via a tunnel and further comprising:
encapsulating, based on a tunnel protocol of the tunnel, and/or encrypting the outgoing data packet in response to changing the source IP address and the destination IP address of the outgoing data packet and wherein transmitting the outgoing data packet further comprises transmitting the encapsulated and/or encrypted outgoing data packet via the tunnel; and
decapsulating, based on the tunnel protocol, and/or decrypting the incoming data packet, wherein changing the source IP address and the destination IP address is in response to decapsulating and/or decrypting the incoming data packet.

14. The method of claim 11, further comprising, at a Domain Name System (“DNS”) server replicator:
identifying, to the computing devices of the local network, the computing devices of the remote network as having IP addresses with the virtual subnet; and
identifying, to the computing devices of the remote network, the computing devices of the local network as having IP addresses with the virtual subnet.

15. The method of claim 14, wherein the DNS server replicator peers with a DNS server of the local network and/or a DNS server of the remote network and identifies, to the DNS server of the local network, the computing devices of the remote network as having IP addresses with the virtual subnet, and identifies, to the DNS server of the remote network, the computing devices of the local network as having IP addresses with the virtual subnet.

16. The method of claim 11, wherein the virtual subnet comprises the local subnet with at least a portion of the local subnet changed to a different value, the gateway is a tunnel endpoint of a tunnel connecting the local network with the remote network, and/or the connecting network is a public network.

17. The method of claim 11, wherein the remote network is a first remote network and further comprising a second remote network connected to computing devices, wherein the computing devices of the local network, the first remote network, and the second remote network each have IP addresses with a same local subnet, and wherein the virtual subnet is a first virtual subnet and further comprising a second virtual subnet, the second virtual subnet non-overlapping with the local subnet and the first virtual subnet, and further comprising:
receiving, at the gateway, a first outgoing data packet from the local computing device being sent to a first remote computing device on the first remote network, the first outgoing data packet comprising a source IP address with the local subnet and the device ID of the local computing device and a destination IP address comprising the first virtual subnet and a device ID of the first remote computing device;
changing, for the first outgoing data packet, the local subnet of the source IP address to the first virtual subnet and changing the first virtual subnet of the destination IP address to the local subnet;
transmitting the first outgoing data packet to the first remote computing device;
receiving, at the gateway, a second outgoing data packet from the local computing device being sent to a second remote computing device on the second remote network, the second outgoing data packet comprising a source IP address with the local subnet and the device ID of the local computing device and a destination IP address comprising the second virtual subnet and a device ID of the second remote computing device;
changing, for the second outgoing data packet, the local subnet of the source IP address to the second virtual subnet and changing the second virtual subnet of the destination IP address to the local subnet; and
transmitting the second outgoing data packet to the second remote computing device.

18. An apparatus comprising:
a network ID module configured to:
determine that a local network and a remote network comprise a same local subnet; and
in response to determining that the local network and remote network comprise the same local subnet, create a virtual subnet, the virtual subnet non-overlapping with the local subnet; and
a DNS server replicator configured to peer with a DNS server of the local network and/or a DNS server of the remote network and to identify, to the DNS server of the local network, computing devices of the remote network as having IP addresses with the virtual subnet, and to identify, to the DNS server of the remote network, computing devices of the local network as having IP addresses with the virtual subnet,
wherein the DNS server of the local network identifies, to the computing devices of the local network, the computing devices of the remote network as having IP addresses with the virtual subnet, and identifies, to the computing devices of the remote network, the computing devices of the local network as having IP addresses with the virtual subnet,
wherein at least a portion of said modules comprise one or more of hardware circuits, programmable hardware circuits and executable code, the executable code stored on one or more computer readable storage media.

19. The apparatus of claim 18, further comprising:
a packet receiver module configured to receive, at a gateway, an outgoing data packet from a local computing device connected to the local network, the outgoing data packet being sent to a remote computing device on the remote network connected to the local network over a connecting network, the outgoing data packet comprising a source IP address with the local subnet and a device identifier (“ID”) of the local computing device and a destination IP address comprising a virtual subnet and device ID of the remote computing device;
a virtual address module configured to change the local subnet of the source IP address of the outgoing data packet to the virtual subnet and to change the virtual subnet of the destination IP address to the local subnet; and
a transmission module configured to transmit the outgoing data packet to the remote computing device.

20. The apparatus of claim 19, wherein:
the packet receiver module is further configured to receive an incoming data packet being transmitted to the local computing device from the remote computing device, the incoming data packet comprising a source IP address with the local subnet and a destination IP address with the virtual subnet;
the virtual address module is further configured to change the local subnet of the source IP address to the virtual subnet and to change the virtual subnet of the destination IP address to the local subnet; and
the transmission module is further configured to transmit the incoming data packet to the local computing device.
